(19) United States
(12) Patent Application Publication
(10) Pub. No.: US 2011/0012802 A1
(43) Pub. Date: Jan. 20, 2011

(54) SLEEVE DISCONE ANTENNA WITH EXTENDED LOW-FREQUENCY OPERATION

(75) Inventors: Michael E. Weinstein, Orlando, FL (US); Rhonessa Irene Villegas, Winter Garden, FL (US)

Correspondence Address: PEACOCK MYERS, P.C., 201 THIRD STREET, N.W., SUITE 1340, ALBUQUERQUE, NM, 87102, US

(73) Assignee: Lockheed Martin Corporation, Bethesda, MD (US)

(21) Appl. No.: 12/839,812

(22) Filed: Jul. 20, 2010

Related U.S. Application Data
(60) Provisional application No. 61/226,894, filed on Jul. 20, 2009.

(51) Int. Cl. H01Q 13/00; H01P 11/00

(52) U.S. Cl. 343/772; 29/600

(57) ABSTRACT

An antenna (and concomitant method of making and communications method) comprising a conical radiating element and a circular radiating element surrounding a base of the conical radiating element.

### CROSS-REFERENCE TO RELATED APPLICATIONS

This application claims priority to and the benefit of the filing of U.S. Provisional Patent Application Ser. No. 61/226,894, entitled “Reduced-Height Sleeve Discone Antenna with Extended Low-Frequency Operation”, filed on Jul. 20, 2009, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The present invention relates to communications antennas and corresponding methods of use and manufacture.

2. Description of Related Art

Certain communications applications, particularly in aeronautics applications, require vertically-polarized, omnidirectional, multiband antennas to support an upgraded data link system. However, aerodynamic constraints hamper the capabilities of such antennas.

The present invention provides methods and apparatuses for accomplishing same. One antenna preferably covers portions of the L, S, and C bands, approximately 1.7 to 5.9 GHz. For good omnidirectional coverage at small elevation and depression angles, the antenna is preferably located on the bottom of the air scoop that protrudes from the underside of the pod. To avoid interference with the pod's loading apparatus and for minimal aerodynamic impact, the antenna should not protrude more than about one inch.

### BRIEF SUMMARY OF THE INVENTION

The present invention is of an antenna (and concomitant method of making and communications method) comprising: a conical radiating element; and a circular radiating element surrounding a base of the conical radiating element. In the preferred embodiment, the antenna additionally comprises a shroud attached to a rim of the conical radiating element. The antenna provides about a 4:1 frequency bandwidth or better, and operates at frequencies between about 1.7 GHz and 5.9 GHz, and/or in the UHF band. The antenna protrudes no more than about one inch from a mounting surface.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a sectional view of one embodiment of the invention;

FIG. 2 is a perspective view of the invention with an optional resistive curtain;

FIG. 3 is a graph of typical voltage standing wave ratio (VSWR) achievable with the invention;

FIG. 4 is a graph of typical input impedance achievable with the invention;

FIG. 5 is a sectional view of another embodiment of the invention;

FIG. 6 is a side view of that embodiment;

FIG. 7 is a front sectional view of that embodiment;

FIG. 8 is a front sectional view showing possible dimensions for that embodiment;

FIG. 9 is a graph of typical VSWR for that embodiment; and

FIG. 10 is a graph of typical input impedance achievable for that embodiment.

### DETAILED DESCRIPTION OF THE INVENTION

The sleeve discone antenna of the invention combines two conventional antenna types to improve performance of a reduced-height design: the (upside-down) discone antenna (conical monopole) and the sleeve monopole antenna. The invention provides an omnidirectional radiation pattern over a wide frequency bandwidth. Specifically, it preferably operates at full efficiency for discone heights as small as about one-eighth wavelength with low VSWR over about a minimum 4:1 frequency bandwidth. Furthermore, low-VSWR operation at much lower frequencies, where the antenna dimensions are a small fraction of a wavelength, is preferably made possible by a resistive shroud that imparts frequency-selective loss. This greatly extends the usable bandwidth, yet reduces antenna efficiency only at these lower frequencies.

The present invention provides wideband performance in a reduced-height configuration, optionally provides a frequency-selective loss technique that extends low-frequency operation, employs a mechanical design that is easily ruggedized, employs a low-cost, readily manufacturable design, and may be housed within a low-profile, aerodynamic radome.

One antenna preferably covers portions of the L, S, and C bands, most preferably approximately 1.7 to 5.9 GHz. For good omnidirectional coverage at small elevation and depression angles, the antenna is preferably located on the bottom of an air scoop that protrudes from the underside of a pod. To avoid interference with the pod's loading apparatus and for minimal aerodynamic impact, the antenna should not protrude more than about one inch.

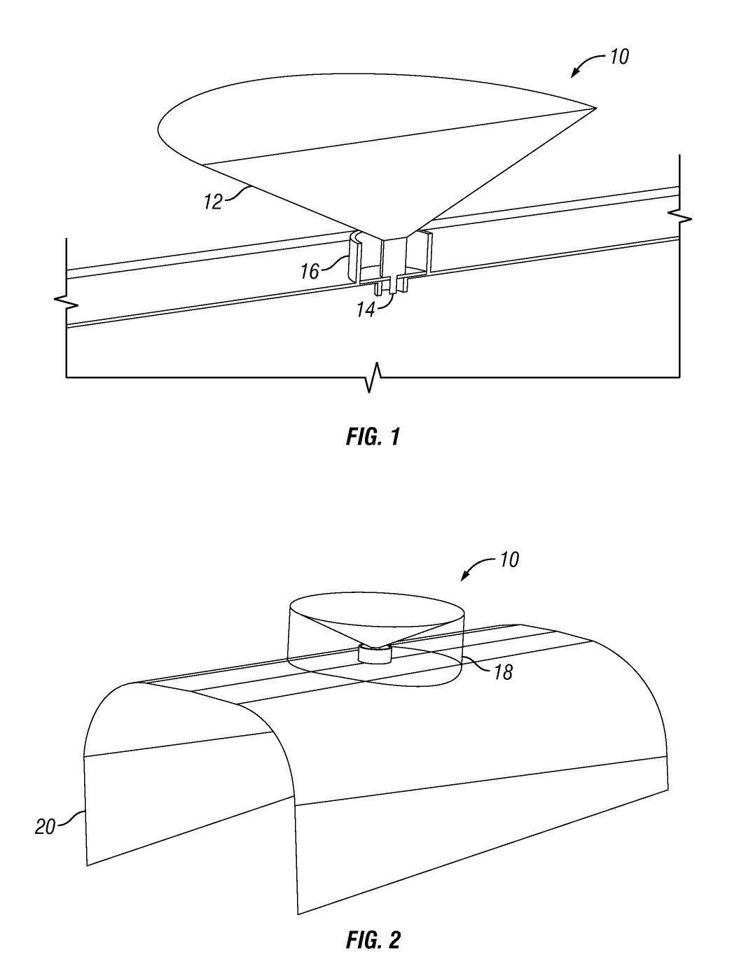

FIGS. 1-2 show one embodiment of the antenna 10 of the invention, comprising conical radiating element 12, coaxial input 14, sleeve 16 (comprising impedance matching section and dielectric spacer), and optional resistive curtain 18 for extended low-frequency performance. In FIG. 2, the invention is shown disposed on a portion of an air scoop 20. Preferred materials for the radiating element include any conventional conductive material, such as brass or aluminum, and materials conventional in fabricating printed circuit boards. Preferred configurations for the resistive curtain include continuous resistive film or resistive strips (e.g., card or printed strips). The curtain operates as a frequency selective method to add loss only at lower frequencies and to allow higher frequencies to pass through.

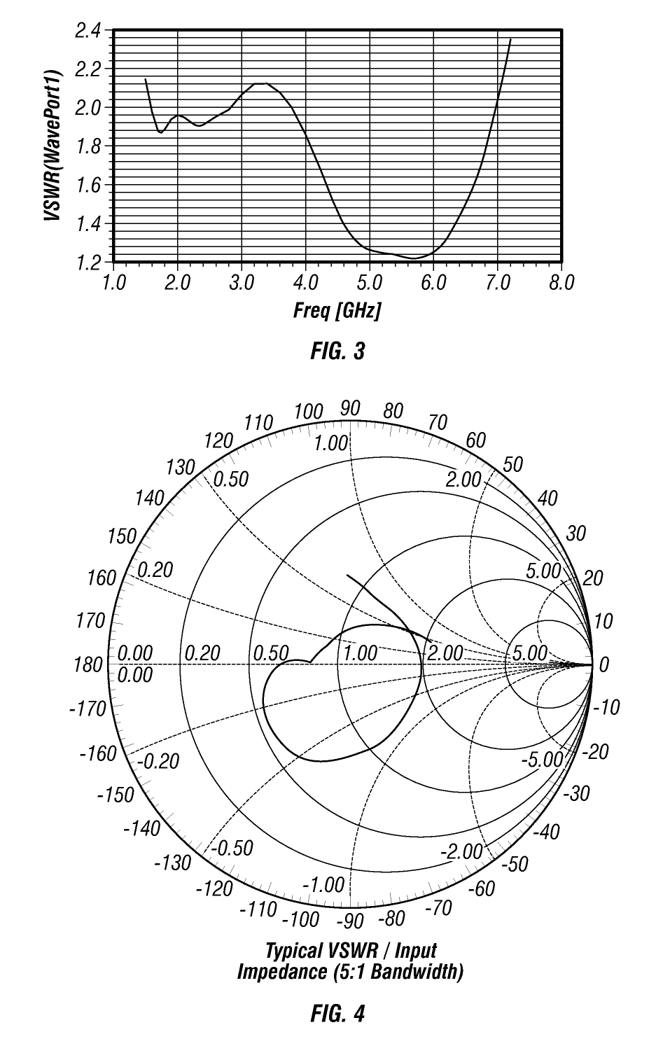

FIG. 3 shows typical voltage standing wave ratios (VSWR) achievable with the embodiment of FIGS. 1-2 in the relevant frequencies. FIG. 4 shows via Smith chart typical input impedance achievable with the embodiment of FIGS. 1-2.

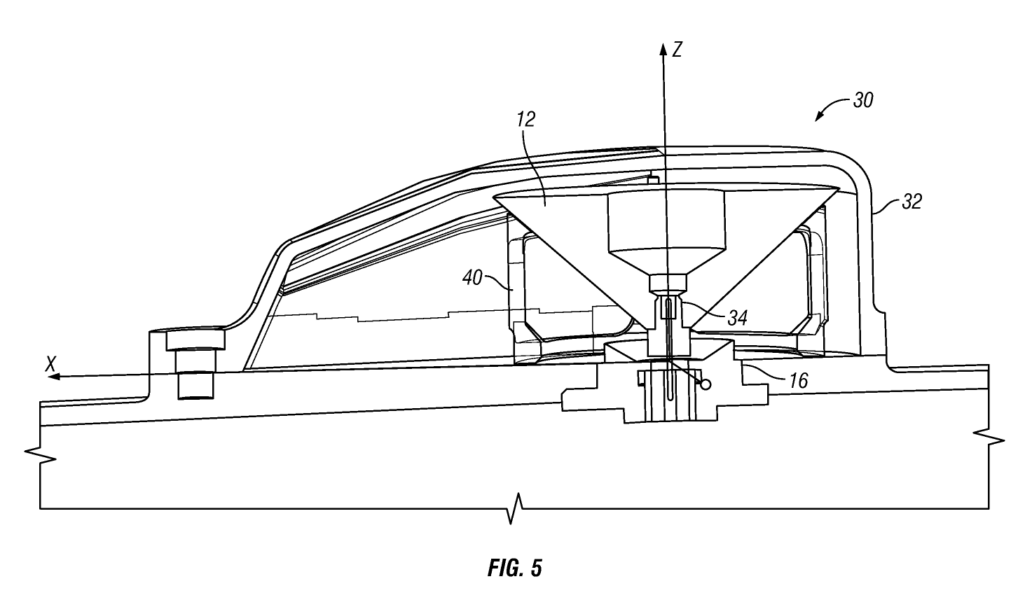

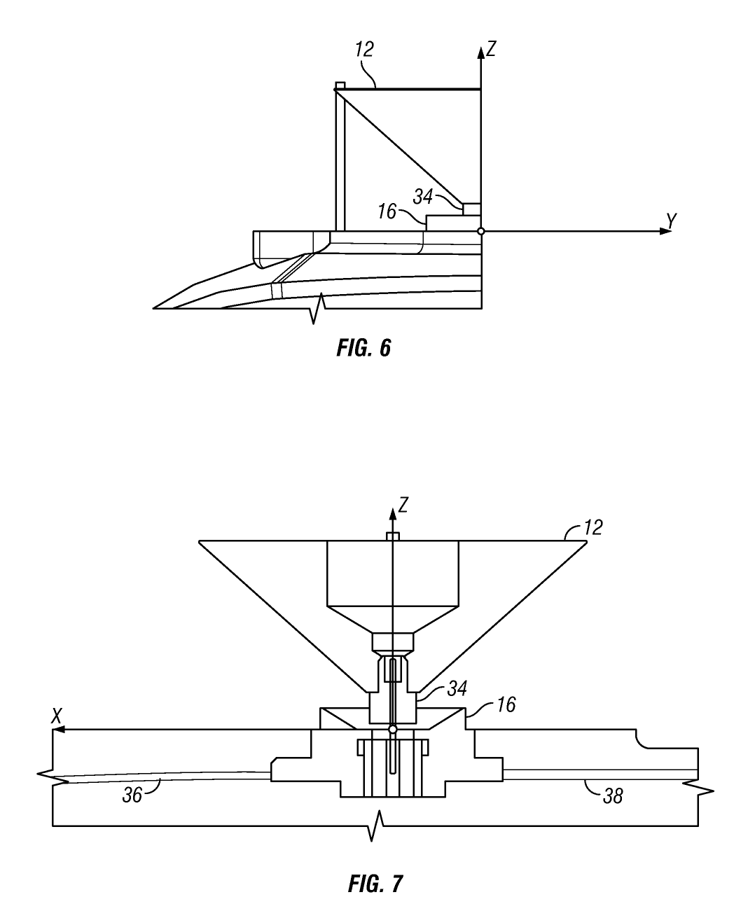

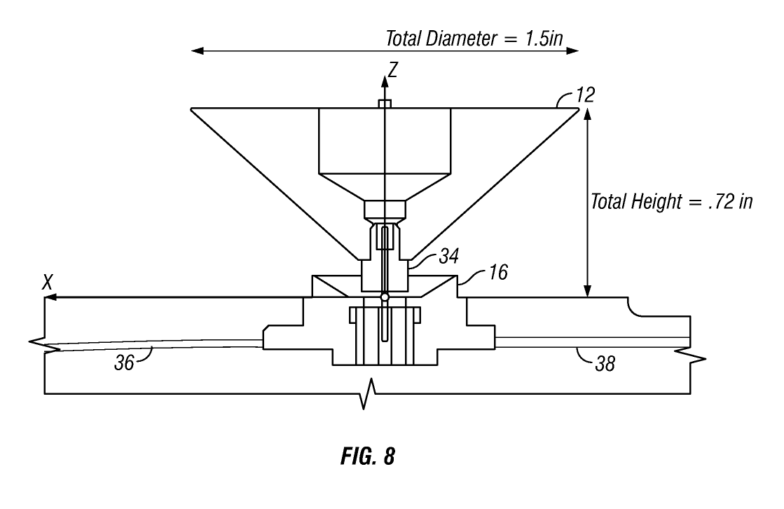

FIGS. 5-8 show another embodiment of the antenna 30 of the invention, comprising conical radiating element 12, probe 34, sleeve 16, and wires 36,38. In FIG. 5, the invention is shown disposed within a radome 32 and supported by support cradle 40.

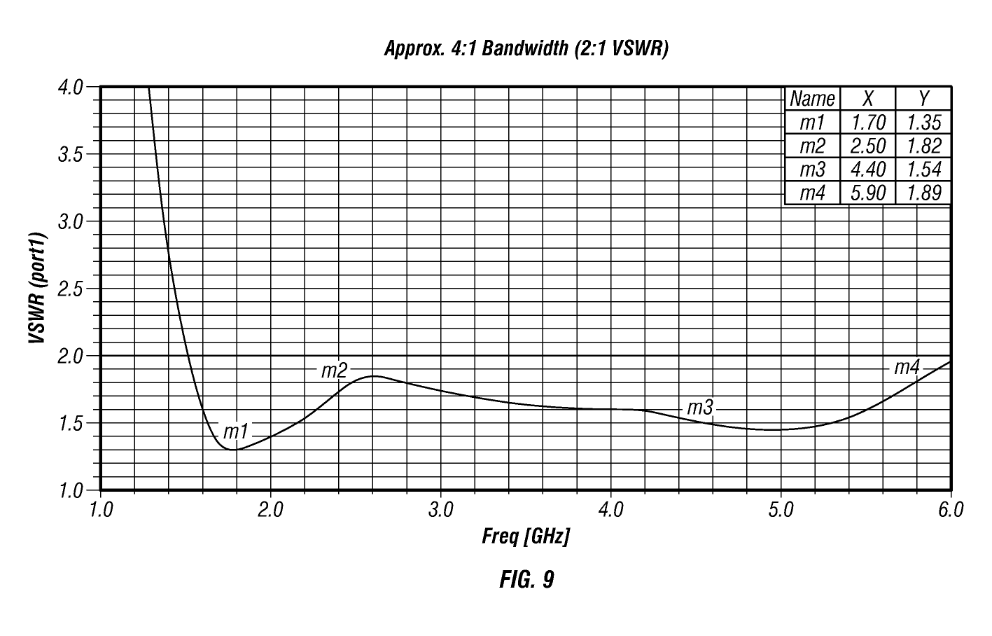

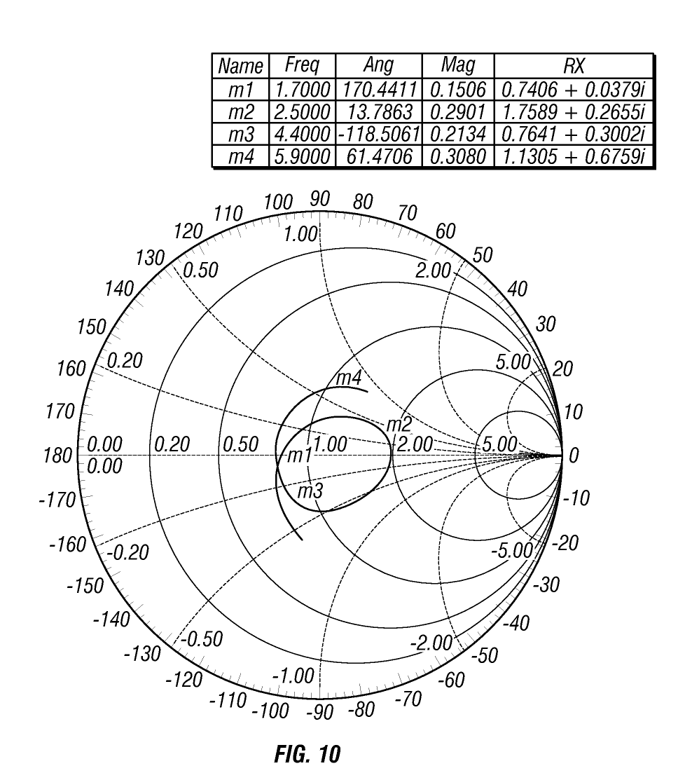

FIG. 9 shows typical VSWR achievable with the embodiment of FIGS. 5-8 in the relevant frequencies. FIG. 10 shows a typical Smith chart for the embodiment of FIGS. 5-8.

The sleeve discone antenna provides at least the following benefits: (1) it provides omnidirectional radiation patterns with high operating efficiency (minimal loss) over a minimum 4:1 frequency bandwidth, thus easily satisfying requirements for the L, S, and C bands; and (2) it provides wideband performance in a reduced-height configuration. Furthermore, the optional resistive curtain implements a frequency-selective loss technique that extends low-frequency operation and provides at least the following additional benefits: (1) it extends operation to lower frequencies, but with reduced antenna gain only at these lower frequencies; (2) it absorbs low-frequency power to provide good VSWR over a very wide frequency bandwidth; (3) it allows substantial high-frequency radiation to pass through and minimally affects the VSWR at these higher frequencies; and (4) it provides very wideband performance in a reduced-height configuration.

Note that in the specification and claims, “about” or “approximately” means within twenty percent (20%) of the numerical amount cited. All computer software disclosed herein may be embodied on any computer-readable medium (including combinations of mediums), including without limitation CD-ROMs, DVD-ROMs, hard drives (local or network storage device), USB keys, other removable drives, ROM, and firmware.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. An antenna comprising:
a conical radiating element; and
a circular radiating element surrounding a base of said conical radiating element.

2. The antenna of claim 1 additionally comprising a shroud attached to a rim of said conical radiating element.

3. The antenna of claim 1 wherein said antenna provides about a 4:1 frequency bandwidth or better.

4. The antenna of claim 1 wherein said antenna operates at frequencies between about 1.7 GHz and 5.9 GHz.

5. The antenna of claim 4 wherein said antenna protrudes no more than about one inch from a mounting surface.

6. The antenna of claim 1 wherein said antenna operates at frequencies in the UHF band.

7. A communications method comprising the steps of:
radiating energy with a conical radiating element; and
radiating energy with a circular radiating element surrounding a base of the conical radiating element.

8. The method of claim 7 additionally comprising the step of imparting frequency selective loss via a shroud attached to a rim of the conical radiating element.

9. The method of claim 7 wherein the method provides about a 4:1 frequency bandwidth or better.

10. The method of claim 7 wherein the method operates at frequencies between about 1.7 GHz and 5.9 GHz.

11. The method of claim 10 wherein the conical radiating element protrudes no more than about one inch from a mounting surface.

12. The method of claim 7 wherein the method operates at frequencies in the UHF band.

13. A method of making an antenna, the method comprising the steps of:
providing a conical radiating element; and
surrounding a base of the conical radiating element with a circular radiating element.

14. The method of claim 13 additionally comprising the step of attaching a shroud to a rim of the conical radiating element.

15. The method of claim 13 wherein the resulting antenna provides about a 4:1 frequency bandwidth or better.

16. The method of claim 13 wherein the resulting antenna operates at frequencies between about 1.7 GHz and 5.9 GHz.

17. The method of claim 16 wherein the resulting antenna protrudes no more than about one inch from a mounting surface.

18. The method of claim 13 wherein the resulting antenna operates at frequencies in the UHF band.
